(19) United States
(12) Patent Application Publication
(10) Pub. No.: US 2023/0313578 A1
(43) Pub. Date: Oct. 5, 2023

(54) HASP PROTECTOR ASSEMBLY AND METHOD OF ASSEMBLING THE SAME

(71) Applicant: Transportation IP Holdings, LLC, Norwalk, CT (US)

(72) Inventors: John D. Anderson, Oswego, IL (US); Walter J. Peach, Montgomery, IL (US)

(21) Appl. No.: 18/171,809

(22) Filed: Feb. 21, 2023

Related U.S. Application Data
(60) Provisional application No. 63/314,515, filed on Feb. 28, 2022.

(51) Int. Cl. E05C 19/00

(52) U.S. Cl. CPC E05C 19/003

(57) ABSTRACT

Hasp protector assembly and method of assembling the same. The hasp protector assembly may include a guard frame that extends from a rotatable end to an opposite fastening end. The rotatable end may be coupled with a door. The hasp protector assembly may also include an anchor bracket coupled with the door. The rotatable end permits the guard frame to rotate to a protective position in which the fastening end can be secured to the anchor bracket. In the protective position, the seal and the hasp locking mechanism are disposed between the guard frame and the door and are visible from opposite sides of the guard frame. The hasp protector assembly may be assembled by securing the anchor bracket and the guard frame to the door and coupling the fastening end to the anchor bracket.

### CROSS-REFERENCE TO RELATED APPLICATIONS

The present application claims the benefit of U.S. Provisional Application No. 63/314,515, filed on 28-February-2022, which is incorporated herein by reference in its entirety.

### BACKGROUND

### Technical Field

Embodiments of the inventive subject matter described herein relate to devices that protect hasp locking mechanisms (e.g., to doors or gates) from tampering or unauthorized use.

### Discussion of Art

Global and regional supply chains include a network of routes that extend between destinations. Various types of vehicles (e.g., ships, trains, trucks, or the like) carry cargo between the destinations of the network. The cargo is typically loaded into and carried within secured compartments, such as an intermodal container. The compartments may be accessed through movable barriers (e.g., doors or panels) that are typically located at an end of the compartment or along a side of the compartment. At various points along the network, the compartments may be opened for inspection or to remove or add cargo. Opening the movable barriers may include swinging the barriers about a hinge, sliding the barriers alongside a wall of the compartment, or separating the barrier entirely from the compartment.

Compartments can be vulnerable to unauthorized access as the compartments travel through the network. For example, intermodal containers that are awaiting to be inspected or awaiting to be loaded/unloaded may be queued in line with other intermodal containers. While waiting, unauthorized individuals may attempt to open the containers and remove at least some of the cargo. To reduce theft or possible tampering, the movable barriers are secured using a locking mechanism.

Hasp locking mechanisms may include two parts that are secured to each other by a seal. For example, a movable hasp may be secured to a fixed staple using a bolt-seal. If the seal is broken before the compartment arrives at its final destination, one can assume at least an attempt was made to open the compartment without authorization. In addition to revealing any suspected trespass, the seals may provide other information, such as a direction of travel of the vehicle, a destination where the compartment was loaded, a final destination of the cargo, or an identification number that identifies the compartment. For example, the seals may be color-coded or include an alphanumeric textual string. To quickly ascertain whether the seal has been broken and/or to quickly identify information represented by the seal, the seals should be at least partially visible to inspectors.

However, for at least one known hasp locking mechanism, thieves have been able to remove the seal without visibly damaging the seal. After accessing the compartment, the hasp locking mechanism and the seal are returned to their original positions and appear to be undamaged. Accordingly, a person inspecting the seals to confirm that the seals are unbroken may not realize that a compartment has been accessed without authorization at some point within the network.

At least some known hasp protector assemblies surround the hasp locking mechanism such that the seal is not readily visible. While providing adequate protection of the hasp locking mechanism, an individual must manually move components of the protector assemblies to view the seal, thereby adding significant time to the inspection process. Accordingly, there is a need for a hasp protector assembly that prevents surreptitious tampering of a seal but that also allows the seal to be readily viewed.

### BRIEF DESCRIPTION

In accordance with one example or aspect, a hasp protector assembly is provided that can include a guard frame extending from a rotatable end to an opposite fastening end. The rotatable end can be configured to be pivotally or rotationally coupled with a door. The door may be secured in a closed, locked state with a seal that may be coupled with a hasp of the door. The hasp protector assembly can also include an anchor bracket that can be configured for coupling with the door in a position where the fastening end of the guard frame can be secured to the anchor bracket by a fastener. The guard frame can be configured to be pivoted or rotated about or around the rotatable end of the guard frame to a protective position. The fastening end of the guard frame can be secured to the anchor bracket by the fastener. The seal and the hasp can be disposed between the guard frame and the door, and the seal and the hasp can be visible from opposite sides of the guard frame while the guard frame is in the protective position.

In accordance with one example or aspect, a hasp protector assembly is provided that can include a rigid elongated body extending from a rotatable end to an opposite fastening end. The rigid elongated body can be configured to rotate or pivot about the rotatable end relative to a door that can be configured to be secured in a closed, locked state with a seal coupled with a hasp of the door. The hasp protector assembly can also include an anchor bracket that can be configured to be coupled with the door. The rigid elongated body may be configured to rotate or pivot about the rotatable end to bring the fastening end into contact with the anchor bracket. The fastening end may be configured to be secured to the anchor bracket by one or more fasteners. The seal and the hasp may be disposed between the rigid elongated body and the door, and the seal and the hasp may be visible from opposite sides of the rigid elongated body while the fastening end of the rigid elongated body is coupled with the anchor bracket.

In accordance with one example or aspect, a method is provided that can include pivotally or rotationally coupling a rotatable end of a guard frame to a door that can be configured to be secured in a closed, locked state with a seal coupled with a hasp of the door. The method may also include coupling an anchor bracket to the door in a position where a fastening end of the guard frame that can be opposite the rotatable end can be secured to the anchor bracket by a fastener. The guard frame may be configured to be pivoted or rotated about or around the rotatable end of the guard frame to a protective position. The fastening end of the guard frame can be secured to the anchor bracket by the fastener. The seal and the hasp may be disposed between the guard frame and the door, and the seal and the hasp may be visible from opposite sides of the guard frame while the guard frame is, for example, in the protective position.

### BRIEF DESCRIPTION OF THE DRAWINGS

The inventive subject matter may be understood from reading the following description of non-limiting embodiments, with reference to the attached drawings, wherein below:

FIG. 1 is an isolated perspective view of a hasp protector assembly in accordance with one embodiment;

FIG. 2 is a side view of a hasp protector assembly in accordance with one embodiment that includes a sectional view of a hasp locking mechanism;

FIG. 3 is a front view of a hasp protector assembly in accordance with one embodiment;

FIG. 4 is a front view of a hasp protector assembly in accordance with one embodiment as a guard frame of the hasp protector assembly moves about a rotatable end of the guard frame between an open position and a protective position;

FIG. 5 is a side view of a hasp protector assembly, in accordance with one embodiment, as a guard frame of the hasp protector assembly moves about a rotatable end of the guard frame between an open position and a protective position;

FIG. 6A illustrates a hasp protector assembly in accordance with one embodiment that is secured to a door of a container and in a fully opened position;

FIG. 6B illustrates the hasp protector assembly in a protective position that shields a hasp locking mechanism and a seal from tampering; and

FIG. 7 is a flow chart illustrating a method of assembling a hasp protector assembly in accordance with one embodiment.

### DETAILED DESCRIPTION

Embodiments of the subject matter described herein relate to hasp protector assemblies and method of using and assembling the same. The hasp protector assemblies may be secured using a seal (e.g., bolt seal). The seal may be designed to provide some information when viewed by an inspector. For example, the seal may have one or more designated colors, alphanumeric texts, or the like that provide the inspector with desired information. Such information may include, for example, the contents of a container or a direction of travel for container (or vehicle carrying the container).

The hasp protector assemblies may resist tampering without obstructing or blocking the seal from view. To this end, the hasp protector assembly may include a rigid guard frame (e.g., shaped metal strip or band) that blocks desired access to the seal. In other guard frame may function as a fence or a shield that only partially surrounds the hasp locking mechanism and seal. For example, the guard frame may block a drill bit from reaching a desired orientation so that a drill cannot drill through the seal or hasp locking mechanism. Moreover, the guard frame may limit space immediately around the seal so that tools may not sufficiently grip the seal for breaking or loosening the seal. Accordingly, the guard frame may function as a fence or wall that prevents some ways of approaching or engaging with the seal and the hasp locking mechanism but still allows the seal to be viewed without removing the guard frame.

For some embodiments, the hasp protector assembly may be assembled with legacy containers that are currently being used in the field. As such, it may not be necessary to replace the containers or even replace the container doors. Instead, the hasp protector assembly may be provided by coupling a guard frame and an anchor (e.g., bracket or plate) to the door at designated positions relative to the hasp locking mechanism.

While one or more embodiments are described in connection with an intermodal container disposed on a rail vehicle system, not all embodiments are limited as such. Unless expressly disclaimed or stated otherwise, the inventive subject matter described herein extends to other types of movable barriers that may be locked. For example, the movable barriers may be doors that slide open or swing open or panels that are removed entirely (e.g., from a wall). The movable barriers may be doors or gates within ships or submarines or within buildings. For embodiments that include shipping containers (e.g., intermodal containers), the containers may be transported on various vehicle systems, such as automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) can be formed from a single vehicle or multiple vehicles.

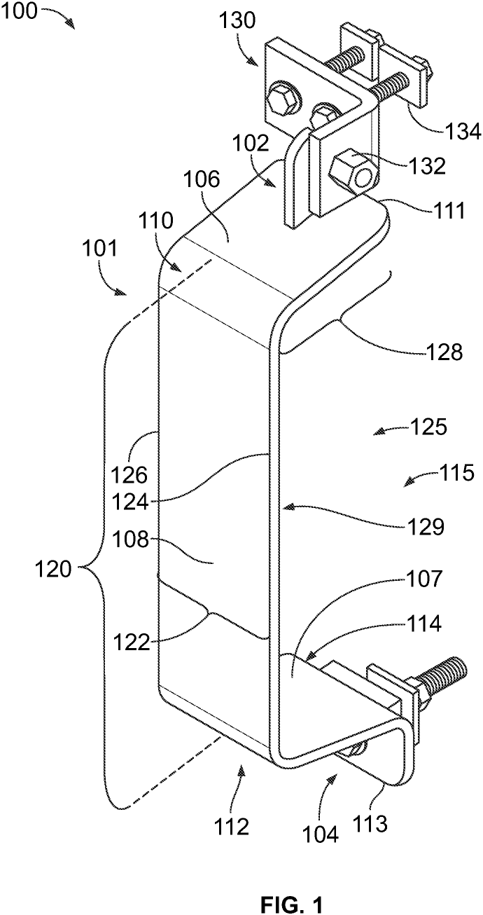

FIG. 1 is an isolated perspective view of a hasp protector assembly 100 in accordance with one embodiment. The hasp protector assembly may be attached to a movable barrier, such as a door or panel, and at least partially cover a hasp locking mechanism. The hasp protector assembly includes a guard frame 101 that extends between a first frame end 102 and a second frame end 104. In the illustrated embodiment of FIG. 1, the second frame end may be referred to as a rotatable end and the first frame end may be referred to as a fastening end. However, either the first frame end or the second frame end may be pivotally or rotationally coupled to the movable barrier. As such, depending upon the configuration of the hasp protector assembly, either the first frame end or the second frame end may be referred to as a “rotatable end” or “rotating end” or “inner end” or referred to as a “fastening end” or “locking end” or “outer end.”

For the embodiment illustrated in FIG. 1, the guard frame has a non-linear that defines a receiving space 115 where a hasp locking mechanism may be disposed. The guard frame may include a narrow band or strip of rigid material (e.g., metal or plastic) that is shaped to define the receiving space with respect to a surface of the movable barrier. The elongated strip prevents tampering with a locking mechanism or a seal by at least partially obstructing access to the hasp locking mechanism or seal.

The guard frame includes an elongated body 108 that extends between a first arm 106 of the first frame end and a second arm 107 of the second frame end. The first and second arms are transversely oriented with respect to the elongated body. The guard frame includes a first curve 110 and a second curve 112. The elongated body extends between the first and second curves of the guard frame. The first arm is defined between a distal edge 111 of the first arm and the first curve. The second arm is defined between a distal edge 113 of the second arm and the second curve. As shown, the second arm also includes a third curve 114. In the illustrated embodiment, the various segments of the guard frame render the guard frame U-shaped or C-shaped. It should be understood that the guard frame may have other shapes. Moreover, one or more of the segments may have a non-linear shape. For example, the elongated body may have a semi-circular shape.

In other embodiments, the guard frame may include multiple elongated bodies or segments. For example, two elongated segments may be joined by another curve (not shown). Moreover, the arms may include curved portions so that the guard frame may be secured to the movable barrier.

The receiving space is sized and shaped to receive at least a portion of a locking mechanism and a corresponding seal. The receiving space has a length 120 that is measured between the first and second arms or frame ends, a width 122 that is measured between opposite frame edges 124, 126 of the guard frame, and a depth 128 that is measured between an interior side 129 of the guard frame and a surface of the movable barrier (not shown). The frame edges that define the width of the guard frame may also define respective side windows 125 through which a seal (not shown) may be viewed.

The hasp protector assembly may also include an anchor bracket 130. The anchor bracket may be secured to the movable barrier in a fixed position using, for example, hardware 134. Alternatively, the anchor bracket may be welded to the movable barrier or be an integral portion of the movable barrier. As shown, the first frame end of the guard frame may be secured to the anchor bracket by a fastener 132. The guard frame may be configured to be pivoted or rotated about or around the second frame end (or rotatable end) of the guard frame between an open position and a protective position. In the protective position, the anchor bracket and the first frame end may be secured to one another using the fastener. In the open position, an individual may have more usable space for interacting with the hasp locking mechanism and the seal.

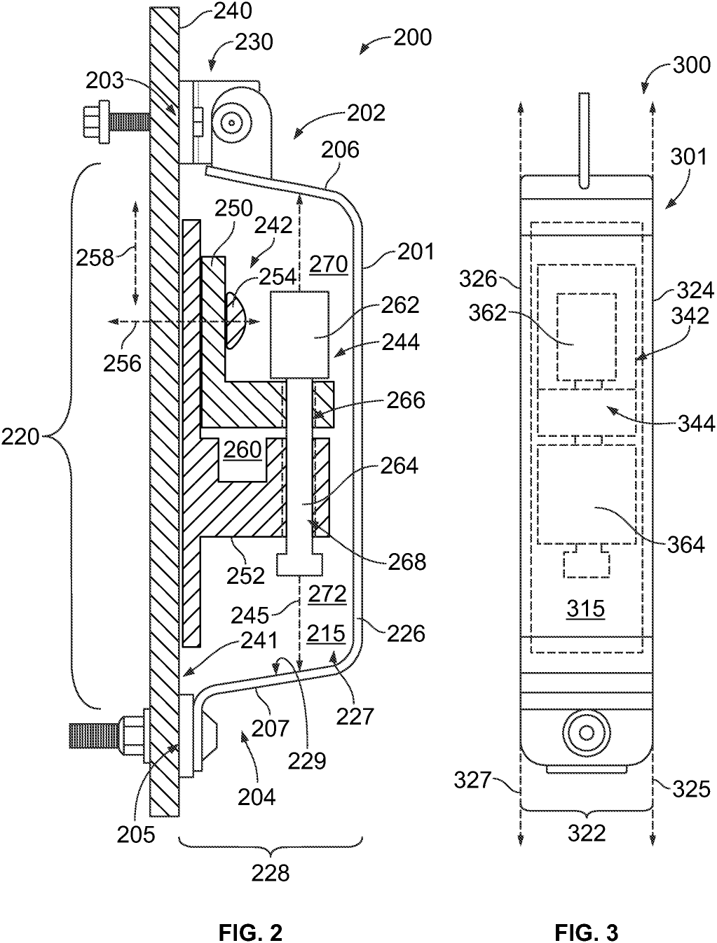

FIG. 2 is a side view of a hasp protector assembly 200 in accordance with one embodiment, which may be similar or identical to the hasp protector assembly of FIG. 1. The hasp protector assembly is secured to a movable barrier 240 (e.g., door) of a compartment. The hasp protector assembly is in a protective position having a first frame end 202 of a guard frame 201 secured with an anchor bracket 230. The anchor bracket is secured to a movable barrier at a coupling point 203. A second frame end 204 of the guard frame is secured to the movable barrier at a coupling point 205.

As shown, a hasp locking mechanism 242 and a seal 244 are disposed between the guard frame of the hasp protector assembly and a surface 241 of the movable barrier. The seal and the hasp locking mechanism are visible from a side window 227 defined by a frame edge 226 of the guard frame while the guard frame is in the protective position. The seal and hasp locking mechanism may also be visible from an opposite side window.

An interior side 229 of the guard frame and the surface of the movable barrier define a receiving space 215 therebetween. The receiving space has a length 220 that is measured between the first frame end and a second frame end and parallel to the surface of the movable barrier. The receiving space also has a depth 228 that is measured between the interior side of the guard frame and the movable barrier.

The hasp locking mechanism disposed within the receiving space includes a first hasp component 250 and a second hasp component 252. The first hasp component is movable and the second hasp component is secured to the movable barrier. The first and second hasp components define a slot 260 therebetween that may receive a latch, lever, bar, or other component. The first hasp component is coupled to the movable barrier using hardware 254 (e.g., bolt) that permits the first hasp component to rotate about a hasp axis 256. Optionally, the first hasp component may have a slot (not shown) through which the hardware extends that permits the hasp to slide (e.g., vertically) along a barrier axis 258. The second hasp component may be affixed to the movable barrier using hardware or by welding. Although FIG. 2 particularly refers to first and second hasp components, the hasp locking mechanism may have more than two hasp components.

The seal includes a head 262 and a body 264 that are secured to one another. To secure the hasp locking mechanism, the body is inserted through a passage 266 of the first hasp component and a passage 268 of the second hasp component. The head is then secured to the body. Accordingly, the seal prevents the first hasp component from inadvertently moving away from the second hasp component. The seal may be certified for high security according to International Organization for Standardization (ISO) 17712 and compliant with Customs Trade Partnership Against Terrorism (C-TPAT). In certain embodiments, the head and body of the seal are permanently secured to one another such that the seal must be broken to open the hasp locking mechanism. In other embodiments, the head and body of the seal may be removably coupled to one another such that the head and body may be separated without sustaining damage.

The seal extends lengthwise along a central axis 245 of the seal between two opposite first and second arms 206, 207 of the guard frame. When the hasp locking mechanism is locked and the guard frame is secured in the protective position, as shown in FIG. 2, the arms extend substantially transverse to the central axis of the seal. The guard frame may block access to a first space 270 that is partially defined by the first arm and is located adjacent to the head. The guard frame may also block access to a second space 272 that is partially defined by the second arm and is located adjacent to an end of the body. The receiving space, including the first and second spaces, may be sized and shaped to limit access to the seal. More specifically, the guard frame may block or prevent tools that are capable of removing the seal without damaging the seal. For example, an individual attempting to drill a hole along an axis of the head or the body will not have sufficient clearance for orienting a drill bit along the axis. Moreover, a person attempting to cut a portion of the body may not be able to insert a tool (e.g., bolt cutters) into the receiving space.

FIG. 3 is a front view of a hasp protector assembly 300 in accordance with one embodiment, which may be similar or identical to other hasp protector assemblies described herein. The hasp protector assembly may include a guard frame 301 that defines a receiving space 315. The guard frame may have a frame edge 324 that defines a side window (not shown) that coincides with a window plane 325. The guard frame may also have a frame edge 326 that coincides with a window plane 327. A width 322 of the guard frame is defined between the frame edges. Although not shown, the side windows may be similar or identical to other side windows described herein. The side windows represent an opening through which the receiving space may be viewed.

The receiving space is a function of the width of the guard frame along with other dimensions and the shape of the guard frame. The receiving space may be sized and shaped to receive a hasp locking mechanism 342 and a seal 344 (represented by phantom lines) that are disposed within the receiving space behind the guard frame. The seal includes a head 362 and a body 364 coupled to one another. In particular embodiments, the width of the guard frame permits the receiving space to include an entirety of the hasp locking mechanism and the seal. In other embodiments, however, a portion of the hasp locking mechanism and/or the seal may clear the window planes such that the receiving space does not include an entirety of the hasp locking mechanism and the seal. Nevertheless, the frame edges and the movable barrier may block a tool from entering the receiving space.

As shown by comparing the guard frames of FIGS. 1-3, the guard frame is open along directions that extend from one of the opposite side windows to another of the opposite side windows. The side windows allow the receiving space to be viewed on either side of the hasp protector assembly while the guard frame is in the protective position. More specifically, the seal is visible from opposite sides of the guard frame. As such, an individual inspecting the seal may view the seal on either side of the hasp protector assembly. In the illustrated embodiment, essentially the entire hasp locking mechanism is also visible from opposite sides of the guard frame such that an individual may view the hasp locking mechanism on either side of the protector assembly. Yet in other embodiments, the seal is visible but the hasp locking mechanism is at least partially blocked from view.

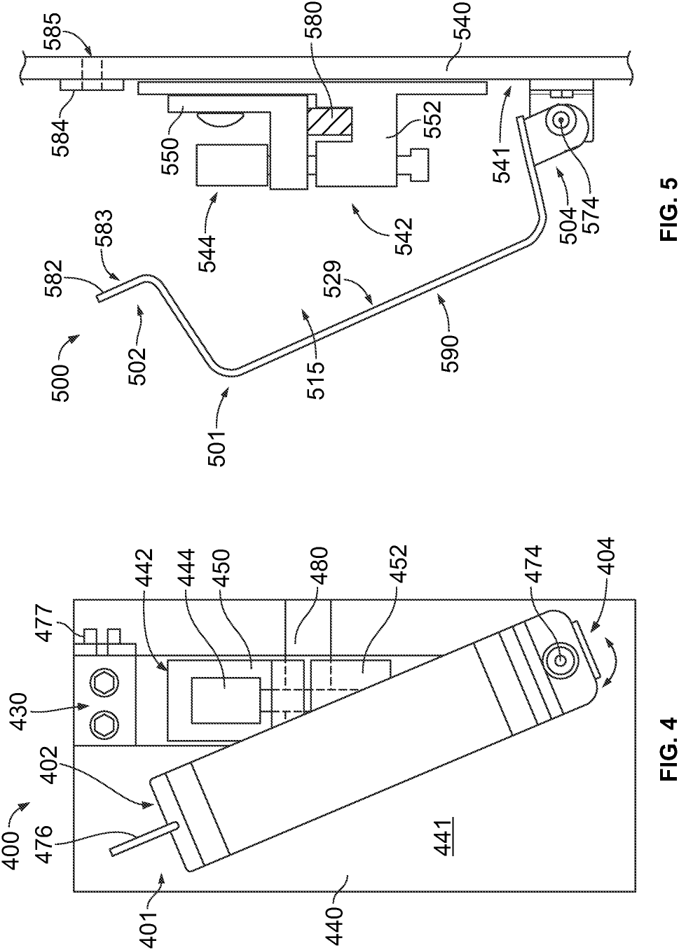

FIG. 4 is a front view of a hasp protector assembly 400 in accordance with one embodiment as a guard frame 401 of the hasp protector assembly moves between an open position and a protective position. In some embodiments, a second frame end 404 is coupled to a movable barrier 440 and rotatable about an axis of rotation 474. As such, the guard frame moves along a plane that is parallel to a surface 441 of the movable barrier. A first frame end 402 may couple to an anchor bracket 430 using, for example, hardware. The anchor bracket is secured in a fixed position to the movable barrier.

As shown in FIG. 4, a hasp locking mechanism 442 has a first hasp component 450 and a second hasp component 452 that are coupled to each other using a seal 444. A latch 480 extends through a slot that is defined between the first and second hasp components. As the guard frame rotates about the axis of rotation and moves into the protective position, a hasp locking mechanism 442 and a seal 444 may be received within a receiving space of the guard frame. In the illustrated embodiment, the guard frame includes a frame extension or fin 476. The frame extension may have a thru-hole that aligns with a thru-hole of the anchor bracket when the guard frame is in the protective position. When the frame extension is positioned adjacent to or abutting the anchor bracket, the hardware (e.g., bolt) may be inserted through the thru-holes and secured (e.g., using a nut) so that the frame extension and the anchor bracket are affixed to one another. In the illustrated embodiment, a nut 477 is integral with the anchor bracket. In other embodiments, the nut may be a separate piece of hardware.

Optionally, the hardware may include anti-theft features. The hardware may include a bolt or screw having a custom-designed head profile and/or drive hole. For example, the fastener may include a bolt or screw having a head with a custom-designed drive hole. The drive hole may have a unique design that receives a complementarily designed bit.

FIG. 5 is a side view of a hasp protector assembly 500, in accordance with one embodiment, as a guard frame 501 of the hasp protector assembly rotates about a rotatable end 504 of the guard frame. The hasp protector assembly is configured to protect a locking mechanism 542 that is secured to a movable barrier 540. The hasp locking mechanism includes first and second hasp components 550, 552. The first and second hasp components are operably engaged with a latch 580 being held between the first and second hasp components. A seal 544 is inserted through respective passages of the first and second hasp components. The seal prevents the first and second hasp components from separating from each other. As such, the latch is held between the first and second hasp components and cannot be removed until the seal is removed.

The hasp protector assembly has an axis of rotation 574 that extends parallel to a surface 541 of a movable barrier 540. As shown in FIG. 5, the guard frame is partially rotated between an open position and a protective position. In a fully opened positioned (not shown), an exterior side 590 of the guard frame may face the movable barrier. In such instances, the underside may face away from the movable barrier.

The guard frame includes a fastening end 502 having a frame extension 582. The frame extension includes a thru-hole 583. The hasp protector assembly also includes an anchor 584 that is secured to the movable barrier and has a thru-hole 585. In the illustrated embodiment, the anchor is a plate that secured to the movable barrier. In other embodiments, the anchor may be a bracket or other component or may be an integral part of the movable barrier. As the guard frame is rotated toward the protective position, an interior side 529 of the guard frame approaches the hasp locking mechanism. When the guard frame nearly reaches the protective position, the hasp locking mechanism advances into a receiving space 515 defined by the guard frame. The thru-holes of the frame extension and the anchor align with one another when the guard frame is in the protective position.

When the thru-holes are aligned, a bolt may be inserted therethrough and engage a nut to secure the frame extension and the movable barrier to one another. Although certain embodiments may utilize a nut and a bolt, other embodiments may use different hardware or different methods for securing the guard frame in the protective position.

Accordingly, FIGS. 4 and 5 each demonstrate how a guard frame may move between a protective position, in which a hasp locking mechanism and a seal are disposed within a receiving space of the guard frame, and an open position, in which the hasp locking mechanism and the seal are not located within the receiving space and are not protected by the guard frame. For each embodiment, the fastening end of the guard frame may move with respect to a surface of the movable barrier while a rotatable end remains coupled to the movable barrier. The fastening end engages and is secured to an anchor (e.g., anchor bracket or anchor plate), thereby affixing the guard frame with respect to the movable barrier. For embodiments in which the guard frame rotates about an axis that is transverse to the movable barrier, the guard frame slides alongside the movable barrier. The hasp locking mechanism and the seal advance into the receiving space through a side window of the guard frame.

For embodiments in which the guard frame rotates about an axis that extends parallel to the movable barrier, the guard frame rotates toward and away from the movable barrier. The interior side of the guard frame faces the hasp locking mechanism and the seal when the guard frame nearly reaches the protective position. Optionally, an exterior side of the guard frame may face the movable barrier when the guard frame is in a fully opened position. In the fully opened position, the underside may face away from the movable barrier.

In alternative embodiments, the guard frame may be coupled to the movable barrier at each of the first and second ends of the guard frame for the open position and the protective position and while transitioning between the two positions. For example, each of the first and second ends may be coupled to the movable barrier through a respective hinge. The guard frame may be swingable about the hinges. In the protective position, the guard frame may be oriented transverse to the movable barrier (e.g., similar to FIG. 1). In the open position, the guard frame may extend parallel to the movable barrier. Similar to the embodiment of FIG. 4, the guard frame may include an extension (e.g., fin-shaped extension) that is positioned adj acent to, for example, an anchor bracket. Each of the anchor bracket and the extension may have thru-holes for receiving hardware.

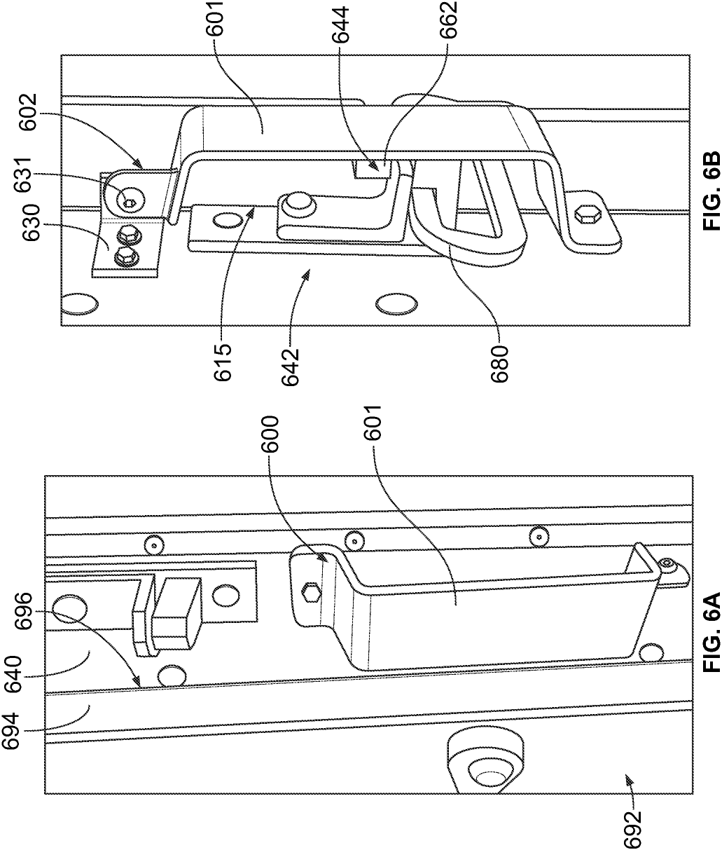

FIG. 6A illustrates a hasp protector assembly 600 in accordance with one embodiment that is secured to a door 640 of a container 692. In FIG. 6A, the hasp protector assembly is in a fully opened position. In the fully opened position, a guard frame 601 of the hasp protector assembly may be permitted to hang vertically alongside the door. More specifically, the guard frame may swing 180° between the fully opened position (shown in FIG. 6A) and a protective position (shown in FIG. 6B).

For some container configurations, the door may be partially positioned behind a wall 694 of the container. A gap 696 exists between the wall and the door. In some embodiments, the hasp protector assembly and the gap are configured relative to one another such that the hasp protector assembly may fit between the door and the wall without damaging the hasp protector assembly, the door, or the wall. In other embodiments, the hasp protector assembly may not be able to fit behind the wall. For such embodiments, the guard frame may be positioned adjacent to an edge of the wall when the door is held open for loading or unloading. A width of the guard frame may permit a latching mechanism (not shown) for holding the door open.

FIG. 6B illustrates the hasp protector assembly in a protective position. A fastening end 602 of the guard frame is coupled to an anchor bracket 630. An anti-theft bolt 631 having a uniquely shaped bit-receiving hole may be used to secure the fastening end and the anchor bracket. As shown, a latch 680 is held by a locking mechanism 642 and secured therein using a seal 644. The locking mechanism, the seal, and the latch are positioned within a receiving space 615 of the guard frame. A head 662 of the seal is visible through a side window of the guard frame. The guard frame includes an opposite side window through which the seal is also visible. Accordingly, the seal is visible from opposite sides of the guard frame.

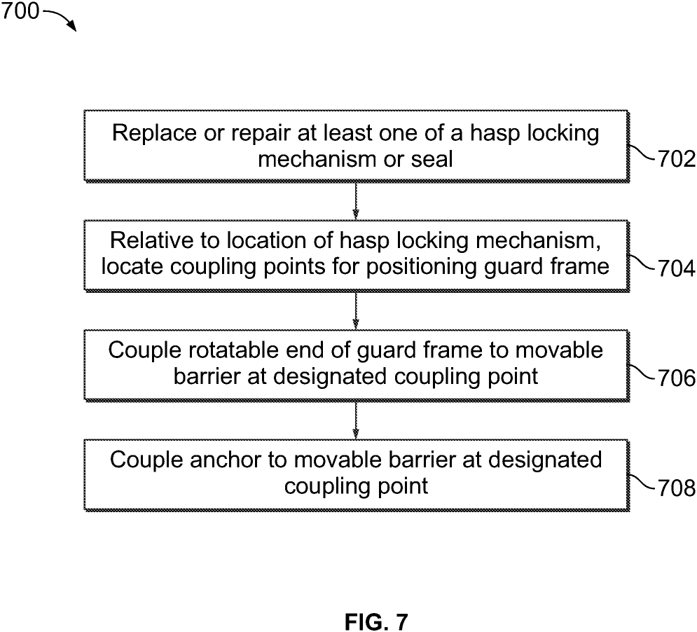

FIG. 7 is a flow chart illustrating a method 700 of assembling a hasp protector assembly in accordance with one embodiment. The method may utilize elements that are similar or identical to the various elements described herein with respect to hasp protector assemblies, seals, and locking mechanisms. In some embodiments, the movable barrier to which the hasp protector assembly will be mounted may be part of a used/legacy storage system. For example, the movable barrier may be a sliding door of an intermodal container that is presently parked at a railyard. Alternatively, the movable barrier is new or unused.

Optionally, the method may include replacing or repairing, at step 702, at least one of a hasp locking mechanism or a seal. For example, if the hasp locking mechanism was damaged in a recent attempt to break into a container, it may be necessary to first replace the entire hasp locking mechanism or only a portion of the hasp locking mechanism (e.g., a hinge component). After the replacing or repairing, the method may include determining locations or coupling points, at step 704, at which the hasp protector assembly should be attached to the movable barrier. For example, in some embodiments, the hasp locking mechanism will be located directly between an anchor and a rotatable end of the guard frame. Determining a location of such coupling points may include measuring a separation distance between the coupling points and/or a distance with respect to the hasp locking mechanism. In some cases, there may be insufficient space or area along the movable barrier for mounting the hasp protector assembly relative to the current position of the hasp locking mechanism. As such, it may be necessary to move the hasp locking mechanism. Accordingly, the method may include determining whether viable coupling points along the movable barrier exists for securing the hasp protector assembly.

At step 706, the method includes coupling a rotatable end of the guard frame to a movable barrier (e.g., door) at one of the determined coupling points. More specifically, the rotatable end of the guard frame may be pivotally or rotationally coupled to the movable barrier on one side or end of the hasp locking mechanism. The rotatable end may be capable of rotating about an axis that extends transverse (e.g., perpendicular) to the movable barrier or an axis that extends parallel to the movable barrier.

The method also includes coupling, at step 708, an anchor (e.g., bracket, plate, or the like) to the movable barrier. The anchor and the rotatable end of the guard frame may be coupled to the movable barrier at predetermined positions relative to one another. More specifically, after the rotatable end is coupled to the door, the guard frame has limited motion. For example, a fastening end of the guard frame may only move through a circular path about the rotatable end. As such, the anchor may be positioned along the circular path and located such that the hasp locking mechanism will be covered by the guard frame when the fastening end is attached to the anchor. As described above, for some embodiments, the anchor and the rotatable end may be located on opposite ends of the hasp locking mechanism.

In accordance with one example or aspect, a hasp protector assembly is provided that includes a guard frame extending from a rotatable end to an opposite fastening end. The rotatable end is configured to be pivotally or rotationally coupled with a door that is configured to be secured in a closed, locked state with a seal that is coupled with a hasp locking mechanism of the door. The hasp protector assembly also includes an anchor bracket configured to be coupled with the door in a position where the fastening end of the guard frame can be secured to the anchor bracket. The guard frame is configured to be pivoted or rotated about or around the rotatable end of the guard frame to a protective position. The fastening end of the guard frame is secured to the anchor bracket by the fastener. The seal and the hasp locking mechanism are disposed between the guard frame and the door. The seal and the hasp locking mechanism are visible from opposite sides of the guard frame while the guard frame is in the protective position.

The guard frame may be generally U-shaped from the rotatable end to the fastening end. The guard frame may have an elongated body connected with the rotatable end and the fastening end by transversely oriented arms. The elongated body of the guard frame may have a width that permits visibility of the seal from the opposite sides of the guard frame. The guard frame may be open along directions that extend from one of the opposite sides to another of the opposite sides. The rotatable end of the guard frame may rotate around or about an axis transversely oriented with respect to a surface of the door that faces and is connected with the guard frame and the anchor bracket.

The guard frame may rotate around or about the rotatable end from the protective position, where the seal and the hasp locking mechanism may be disposed between the guard frame and the door, to an open position, where the guard frame is below the seal and the hasp locking mechanism. In the open position, the seal and the hasp locking mechanism may not be between the guard frame and the door.

In accordance with one example or aspect, a hasp protector assembly is provided that includes a rigid elongated body extending from a rotatable end to an opposite fastening end. The rigid elongated body may rotate or pivot about the rotatable end relative to a door that is configured to be secured in a closed, locked state with a seal coupled with a hasp locking mechanism of the door. The hasp protector assembly also includes an anchor bracket that may be coupled with the door. The rigid elongated body may rotate or pivot about the rotatable end to bring the fastening end into contact with the anchor bracket. The fastening end may be secured to the anchor bracket by one or more fasteners. The seal and the hasp locking mechanism may be disposed between the rigid elongated body and the door. The seal and the hasp locking mechanism may be visible from opposite sides of the rigid elongated body while the fastening end of the rigid elongated body is coupled with the anchor bracket.

The rigid elongated body may be generally U-shaped from the rotatable end to the fastening end. The rigid elongated body may be connected with the rotatable end and the fastening end by transversely oriented arms. The rigid elongated body may have a width that permits visibility of the seal from the opposite sides of the rigid elongated body. The rigid elongated body may be open along directions that extend from one of the opposite sides to another of the opposite sides. The rotatable end of the rigid elongated body may rotate around or about an axis transversely oriented with respect to a surface of the door that faces and is connected with the rigid elongated body and the anchor bracket.

The rigid elongated body may rotate around or about the rotatable end from a first position, where the seal and the hasp locking mechanism are disposed between the guard frame and the door, to a different, second position where the rigid elongated body is below the seal and the hasp locking mechanism. In the second position, the seal and the hasp locking mechanism are not between the rigid elongated body and the door.

In accordance with one example or aspect, a method is provided that includes pivotally or rotationally coupling a rotatable end of a guard frame to a door that is configured to be secured in a closed, locked state with a seal coupled with a hasp locking mechanism of the door. The method also includes coupling an anchor bracket to the door in a position where a fastening end of the guard frame that is opposite the rotatable end can be secured to the anchor bracket by a fastener. The guard frame may pivot or rotate about or around the rotatable end of the guard frame to a protective position. The fastening end of the guard frame may be secured to the anchor bracket by the fastener. The seal and the hasp locking mechanism may be disposed between the guard frame and the door, and the seal and the hasp locking mechanism may be visible from opposite sides of the guard frame while the guard frame is in the protective position.

The rotatable end of the guard frame may be pivotally or rotationally coupled to the door and the anchor bracket is coupled with the door such that the seal is accessible from the opposite sides of the guard frame. The rotatable end of the guard frame may be pivotally or rotationally coupled to the door such that the guard frame rotate around or about an axis transversely oriented with respect to a surface of the door that faces and is connected with the guard frame and the anchor bracket.

The rotatable end of the guard frame may be pivotally or rotationally coupled to the door such that the guard frame rotates around or about the rotatable end from the protective position where the seal and the hasp locking mechanism are disposed between the guard frame and the door to an open position where the guard frame is below the seal and the hasp locking mechanism. In the open position, the seal and the hasp locking mechanism are not between the guard frame and the door.

As used herein, an element or step recited in the singular and proceeded with the word “a” or “an” do not exclude the plural of said elements or operations, unless such exclusion is explicitly stated. Furthermore, references to “one embodiment” of the invention do not exclude the existence of additional embodiments that incorporate the recited features. Moreover, unless explicitly stated to the contrary, embodiments “comprising,” “comprises,” “including,” “includes,” “having,” or “has” an element or a plurality of elements having a particular property may include additional such elements not having that property. In the appended claims, the terms “including” and “in which” are used as the plain-English equivalents of the respective terms “comprising” and “wherein.” Moreover, in the following claims, the terms “first,” “second,” and “third,” etc. are used merely as labels, and do not impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function devoid of further structure.

The above description is illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein define the parameters of the inventive subject matter, they are exemplary embodiments. Other embodiments will be apparent to one of ordinary skill in the art upon reviewing the above description. The scope of the inventive subject matter should, therefore, be determined with reference to the appended claims, along with the full scope of equivalents to which such claims are entitled.

This written description uses examples to disclose several embodiments of the inventive subject matter, including the best mode, and to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

A reference herein to a patent document or any other matter identified as prior art, is not to be taken as an admission that the document or other matter was known or that the information it contains was part of the common general knowledge as at the priority date of any of the claims.

We claim:

1. A hasp protector assembly comprising:
a guard frame extending from a rotatable end to an opposite fastening end, the rotatable end configured to be pivotally or rotationally coupled with a door that is configured to be secured in a closed, locked state with a seal that is coupled with a hasp locking mechanism of the door; and
an anchor bracket configured to be coupled with the door in a position where the fastening end of the guard frame can be secured to the anchor bracket, the guard frame configured to be pivoted or rotated about or around the rotatable end of the guard frame to a protective position,
wherein the fastening end of the guard frame is secured to the anchor bracket by the fastener, the seal and the hasp locking mechanism are disposed between the guard frame and the door, and the seal and the hasp locking mechanism are visible from opposite sides of the guard frame while the guard frame is in the protective position.

2. The hasp protector assembly of claim 1, wherein the guard frame is generally U-shaped from the rotatable end to the fastening end.

3. The hasp protector assembly of claim 1, wherein the guard frame has an elongated body connected with the rotatable end and the fastening end by transversely oriented arms.

4. The hasp protector assembly of claim 3, wherein the elongated body of the guard frame has a width that permits visibility of the seal from the opposite sides of the guard frame.

5. The hasp protector assembly of claim 1, wherein the guard frame is open along directions that extend from one of the opposite sides to another of the opposite sides.

6. The hasp protector assembly of claim 1, wherein the rotatable end of the guard frame is configured to rotate around or about an axis transversely oriented with respect to a surface of the door that faces and is connected with the guard frame and the anchor bracket.

7. The hasp protector assembly of claim 1, wherein the guard frame is configured to rotate around or about the rotatable end from the protective position where the seal and the hasp locking mechanism are disposed between the guard frame and the door to an open position where the guard frame is below the seal and the hasp locking mechanism, and the seal and the hasp locking mechanism are not between the guard frame and the door.

8. A hasp protector assembly comprising:
a rigid elongated body extending from a rotatable end to an opposite fastening end, the rigid elongated body configured to rotate or pivot about the rotatable end relative to a door that is configured to be secured in a closed, locked state with a seal coupled with a hasp locking mechanism of the door; and
an anchor bracket configured to be coupled with the door, the rigid elongated body configured to rotate or pivot about the rotatable end to bring the fastening end into contact with the anchor bracket, the fastening end configured to be secured to the anchor bracket by one or more fasteners, wherein the seal and the hasp locking mechanism are disposed between the rigid elongated body and the door, and the seal and the hasp locking mechanism are visible from opposite sides of the rigid elongated body while the fastening end of the rigid elongated body is coupled with the anchor bracket.

9. The hasp protector assembly of claim 8, wherein the rigid elongated body is generally U-shaped from the rotatable end to the fastening end.

10. The hasp protector assembly of claim 8, wherein the rigid elongated body is connected with the rotatable end and the fastening end by transversely oriented arms.

11. The hasp protector assembly of claim 10, wherein the rigid elongated body has a width that permits visibility of the seal from the opposite sides of the rigid elongated body.

12. The hasp protector assembly of claim 8, wherein the rigid elongated body is open along directions that extend from one of the opposite sides to another of the opposite sides.

13. The hasp protector assembly of claim 8, wherein the rotatable end of the rigid elongated body is configured to rotate around or about an axis transversely oriented with respect to a surface of the door that faces and is connected with the rigid elongated body and the anchor bracket.

14. The hasp protector assembly of claim 8, wherein the rigid elongated body is configured to rotate around or about the rotatable end from a first position where the seal and the hasp locking mechanism are disposed between the guard frame and the door to a different, second position where the rigid elongated body is below the seal and the hasp locking mechanism, and the seal and the hasp locking mechanism are not between the rigid elongated body and the door.

15. A method comprising:
pivotally or rotationally coupling a rotatable end of a guard frame to a door that is configured to be secured in a closed, locked state with a seal coupled with a hasp locking mechanism of the door; and
coupling an anchor bracket to the door in a position where a fastening end of the guard frame that is opposite the rotatable end can be secured to the anchor bracket by a fastener, the guard frame configured to be pivoted or rotated about or around the rotatable end of the guard frame to a protective position,
wherein the fastening end of the guard frame is secured to the anchor bracket by the fastener, the seal and the hasp locking mechanism are disposed between the guard frame and the door, and the seal and the hasp locking mechanism are visible from opposite sides of the guard frame while the guard frame is in the protective position.

16. The method of claim 15, wherein the rotatable end of the guard frame is pivotally or rotationally coupled to the door and the anchor bracket is coupled with the door such that the seal is accessible from the opposite sides of the guard frame.

17. The method of claim 15, wherein the rotatable end of the guard frame is pivotally or rotationally coupled to the door such that the guard frame rotate around or about an axis transversely oriented with respect to a surface of the door that faces and is connected with the guard frame and the anchor bracket.

18. The method of claim 15, wherein the rotatable end of the guard frame is pivotally or rotationally coupled to the door such that the guard frame rotates around or about the rotatable end from the protective position where the seal and the hasp locking mechanism are disposed between the guard frame and the door to an open position where the guard frame is below the seal and the hasp locking mechanism, and the seal and the hasp locking mechanism are not between the guard frame and the door.

19. The method of claim 15, wherein the method includes locating a container that has the door, the container being previously-used for transporting cargo, and determining, relative to the hasp locking mechanism, a coupling point for the rotatable end and a coupling point for the anchor bracket.

20. The method of claim 15, wherein the seal extends lengthwise along a central axis of the seal between two opposite arms of the guard frame, the arms extending substantially transverse to the central axis.
